(19) United States
(12) Patent Application Publication
(10) Pub. No.: US 2022/0212215 A1
(43) Pub. Date: Jul. 7, 2022

(54) MIXING APPARATUS

(71) Applicant: HONDA MOTOR CO., LTD., Tokyo (JP)

(72) Inventors: Naoto Ishii, Tokyo (JP); Yoshihiro Kawahara, Tokyo (JP); Satoshi Shinozaki, Tokyo (JP); Tomoyuki Uemura, Tokyo (JP)

(21) Appl. No.: 17/567,919

(22) Filed: Jan. 4, 2022

(30) Foreign Application Priority Data
Jan. 7, 2021 (JP) 2021-001664

(51) Int. Cl. B05B 11/00

(52) U.S. Cl. CPC B05B 11/0081; B05B 11/3042; B05B 11/0089

(57) ABSTRACT

A mixing apparatus includes: a first introduction port that is provided on a further upstream side than a mix acceleration part in a mixer tube and allows introduction of a liquid agent; a second introduction port that is provided on the further upstream side than the mix acceleration part in the mixer tube and allows introduction of a substance for removing the liquid agent; and a piston that is provided on the upstream side of the mixer tube and that opens one of the first introduction port and the second introduction port and closes another of the first introduction port and the second introduction port by stroking in the axis direction of the mixer tube.

### CROSS-REFERENCE TO RELATED APPLICATION

Priority is claimed on Japanese Patent Application No. 2021-001664, filed on Jan. 7, 2021, the contents of which are incorporated herein by reference.

### BACKGROUND

### Field of the Invention

The present invention relates to a mixing apparatus.

### Background

For example, Japanese Unexamined Patent Application, First Publication No. 2007-1115 discloses a structure in which a slit along a longitudinal direction is provided below a circumferential part of a nozzle of a mixing head apparatus, and a residual mixture is blown off by blowing high-pressure air from the slit.

### SUMMARY

However, in the above-described configuration of the related art, the residual mixture is simply blown off by blowing air from the slit, and a problem regarding the removability of the residual mixture remains. Specifically, in a mixing apparatus for generating a urethane pad of a vehicle having a large discharge amount, there is a problem in that since a tube length of a nozzle is increased accordingly, it becomes further difficult to remove the residual mixture.

An object of an aspect of the present invention is to provide a mixing apparatus that can facilitate removal of a residual material and improve a cleaning performance

A mixing apparatus according to a first aspect of the present invention is a mixing apparatus in which through a mixer tube having a mix acceleration part a plurality of liquid agents are flowed in an axis direction of the mixer tube and are mixed, the apparatus including: a first introduction port that is provided on a further upstream side in a flow direction of a liquid agent than the mix acceleration part in the mixer tube and allows introduction of the liquid agent; a second introduction port that is provided on the further upstream side in the flow direction of the liquid agent than the mix acceleration part in the mixer tube and allows introduction of a substance for removing the liquid agent; and a piston that is provided on the upstream side of the mixer tube and that opens one of the first introduction port and the second introduction port and closes another of the first introduction port and the second introduction port by stroking in the axis direction of the mixer tube.

According to this configuration, since the first introduction port and the second introduction port are selectively opened and closed using the piston in the mixer tube as a valve, it is possible to easily switch between a liquid agent mix process and a liquid agent removal process. That is, the piston strokes to a position where the first introduction port is opened and the second introduction port is closed, and thereby, it is possible to perform the liquid agent mix process in which the liquid agents are mixed. Further, the piston strokes to a position where the first introduction port is closed and the second introduction port is opened, and thereby, it is possible to perform the liquid agent removal process in which the liquid agents that remain in the mixer tube are removed. In the liquid agent removal process, since the material for cleaning is introduced from the further upstream side than the mix acceleration part, it is possible to facilitate removal of the liquid agent that remains in the mix acceleration part and improve a cleaning performance of the mixing apparatus.

In a second aspect, the piston may include a liquid agent removal part that is formed on an outer circumferential side on an end part on a downstream side opposite to the upstream side in the axis direction, is in sliding contact with an inner circumferential surface of the mixer tube, and removes a liquid agent which adheres to the inner circumferential surface.

According to this configuration, since the liquid agent removal part removes the liquid agent that adheres to the inner circumferential surface of the mixer tube in accordance with the stroke of the piston, it is further difficult for the liquid agent to remain in the liquid agent removal process, and it is possible to improve the cleaning performance of the mixing apparatus. Further, it is possible to prevent the liquid agent from flowing to the further upstream side than the liquid agent removal part and prevent the liquid agent from flowing into the first introduction port or the second introduction port that is closed by the piston.

In a third aspect, the piston may be formed in a hollow shape having a bottom that opens to a downstream side opposite to the upstream side in the axis direction, and a piston outer circumferential surface on a further upstream side than the liquid agent removal part in the piston may include: a piston-side first introduction port that overlaps the first introduction port in a view from a radial direction of the mixer tube and opens the first introduction port through an internal space of the piston when the piston is at a first stroke position that closes the second introduction port; and a piston-side second introduction port that overlaps the second introduction port in the view from the radial direction of the mixer tube and opens the second introduction port through the internal space of the piston when the piston is at a second stroke position that closes the first introduction port.

According to this configuration, since the first introduction port and the second introduction port are opened through the internal space of the hollow piston, it is possible to easily realize switching between opening and closing of the first introduction port and the second introduction port using the piston as a valve. Further, since the substance for removing the liquid agent is introduced from the further upstream side than the liquid agent removal part of the piston, it is possible to remove the liquid agent efficiently and in a wide range including the vicinity of the liquid agent removal part.

In a fourth aspect, the piston may be divided into a first piston and a second piston in the axis direction, one of the first piston and the second piston may be connected to a drive source and be driven by a drive force of the drive source, the other of the first piston and the second piston may be capable of being held at a predetermined axis direction position to be separated from the one by a bias force different from the drive force, and the other of the first piston and the second piston may be capable of stroking from the axis direction position against the bias force by the one stroking and being engaged with the other.

According to this configuration, since the piston that opens and closes the first introduction port and the second introduction port is divided and can stroke separately, it is possible to realize an irregular operation at the time of switching of the process such as an operation in which a separation piston is held at the predetermined axis direction position and maintains a prescribed flow path open/closed state while increasing the stroke of a drive piston and enhancing the degree of freedom of the flow path switching.

In a fifth aspect, the second introduction port that allows introduction of the substance for removing the liquid agent may be arranged on a further downstream side opposite to the upstream side than the first introduction port that allows introduction of the liquid agent.

According to this configuration, since the second introduction port that introduces the substance for removing the liquid agent is arranged close to the mix acceleration part, it is possible to further easily remove the liquid agent in the liquid agent removal process and improve the cleaning performance of the mixing apparatus.

In a sixth aspect, the mix acceleration part may include an element on which a plurality of opening portions are formed and which facilitates mixing of the liquid agent, the element may include a plurality of remaining parts that avoid the opening portions and are aligned in a circumferential direction of the mixer tube, and a guide surface that is inclined to be positioned on one side of the circumferential direction toward a downstream side from the upstream side may be formed on the upstream side of the remaining parts.

According to this configuration, since the guide surface that is inclined toward the one side in the circumferential direction is formed on the plurality of remaining parts that are aligned in the circumferential direction in the element, the liquid agent is guided to be swirled in the circumferential direction by a plurality of guide surfaces when the liquid agent passes through the mix acceleration part. Thereby, it is possible to further efficiently perform mixing of the liquid agent.

In a seventh aspect, the mix acceleration part may be constituted of a plurality of elements on which a plurality of opening portions are formed, which facilitate mixing of the liquid agent, and which are aligned in the axis direction, each of the elements may include: a first element which forms a flat plate shape that crosses the axis direction and on which a plurality of first opening portions are formed; and a second element which forms a conical shape protruding to a downstream side opposite to the upstream side in the axis direction and on which a plurality of second opening portions are formed, the first element and the second element may form a pair with each other and constitute an element pair, and the second element having a conical shape may be arranged on the further downstream side than the first element having a flat plate shape in the element pair.

According to this configuration, in the element pair constituted of the first element having a flat plate shape and the second element having a conical shape, since the second element having a conical shape is arranged on the downstream side, when a material for cleaning is introduced from the upstream side in the liquid agent removal process, the liquid agent is easily discharged to the downstream side from the front end protruding to the downstream side in the second element. Therefore, it is further difficult for the liquid agent to remain in the mixer tube, and it is possible to improve the cleaning performance of the mixing apparatus. Further, a mixed liquid passes through the element on which a plurality of openings are formed, and thereby, it is possible to improve a mixing property of a urethane liquid (polyol, prepolymer polyol, prepolymer isocyanate, and the like) having a high viscosity.

According to an aspect of the present invention, it is possible to provide a mixing apparatus that can facilitate removal of a residual material and improve a cleaning performance.

### BRIEF DESCRIPTION OF THE DRAWINGS

FIG. 1 is a cross-sectional view of a mixing apparatus according to an embodiment of the present invention.

FIG. 2 is a II arrow view of FIG. 1.

FIG. 3 is a III arrow view of FIG. 1.

FIG. 4 is a cross-sectional view when a piston in the mixing apparatus is at a first stroke position.

FIG. 5 is a cross-sectional view when the piston in the mixing apparatus is at a second stroke position.

FIG. 6 is a perspective view including a cross-section of the mixing apparatus.

FIG. 7 is a perspective view showing a modified example of a first element of the mixing apparatus.

FIG. 8 is a cross-sectional view of the first element shown in FIG. 7.

FIG. 9 is a cross-sectional view showing another modified example of the first element shown in FIG. 7.

FIG. 10 is a cross-sectional view when a piston of a mixing apparatus according to a second embodiment of the present invention is at a first stroke position.

FIG. 11 is a cross-sectional view when the piston of the mixing apparatus according to the second embodiment of the present invention is at a second stroke position.

### DESCRIPTION OF EMBODIMENTS

Hereinafter, an embodiment of the present invention will be described with reference to the drawings. An arrow Z that indicates a vertical direction for ease of explanation is shown at a suitable position in the drawings used in the following description.

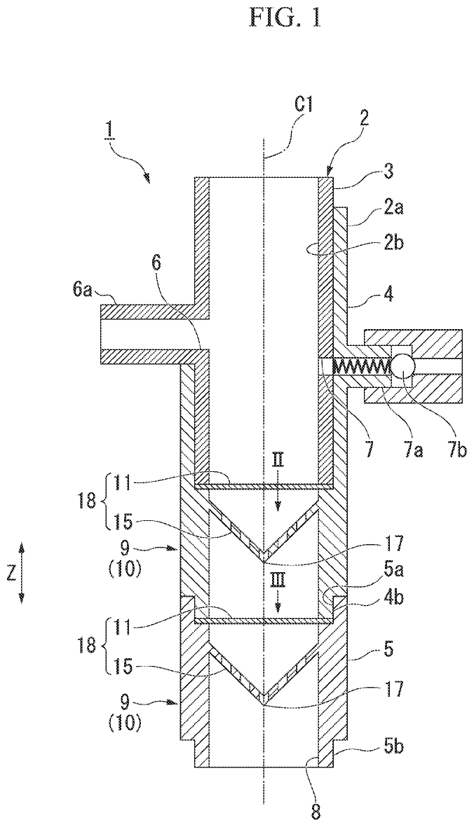

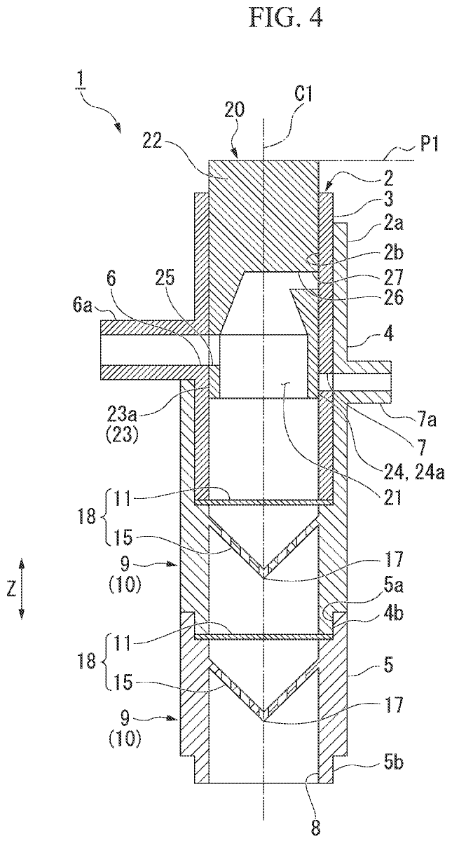

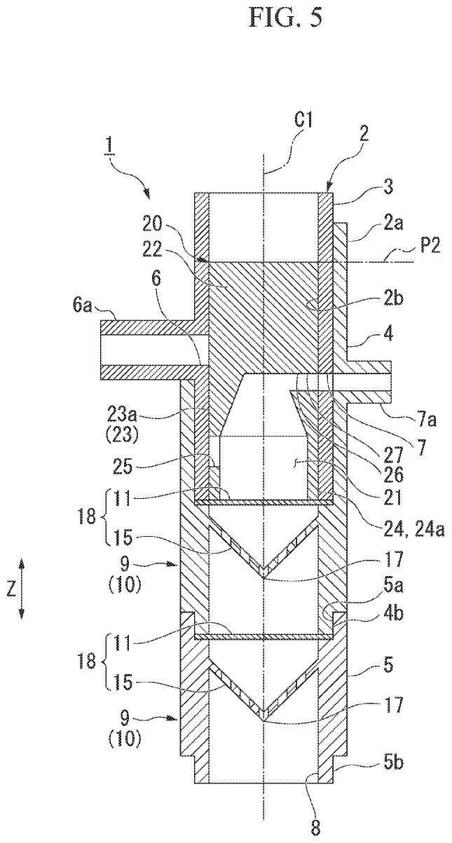

A mixing head 1 shown in in FIG. 1, FIG. 4, and FIG. 5 is a mixer for mixing a two-liquid curable resin, for example, when forming a urethane pad. In the mixing head 1, through a mixer tube 2 having a cylindrical shape and extending straight, a plurality of liquid agents (molding materials) supplied by a material supply device (not shown) are caused to flow in an axis direction of the mixer tube 2, are caused to pass through a mix acceleration part 10 of the mixer tube 2, are stirred and mixed, and are then derived from an end opening (a derivation port 8) of the mixer tube 2. The mixing head 1 is constituted as a stationary mixing apparatus without a drive part.

Hereinafter, an upstream side and a downstream side in a flow direction of the liquid agent that flows in the mixer tube 2 are simply referred to as an “upstream side” and a “downstream side”. The flow direction of the liquid agent corresponds to the axis direction of the mixer tube 2. The mixing head 1 of the embodiment is arranged in a posture in which the axis direction of the mixer tube 2 is directed in a vertical direction, and a lower end opening of the mixer tube 2 is the derivation port 8; however, the embodiment is not limited to the use in this arrangement. A line Cl in the drawing represents a center axis line of the mixer tube 2.

The mixer tube 2 includes a mix acceleration part 10 at a lower part on the derivation port 8 side (downstream side). A piston 20 is inserted in an upper part on the upstream side of the mixer tube 2 and is held. The piston 20 functions as a valve for opening and closing a plurality of introduction ports 6 and 7 that penetrate through an upper part of a circumferential wall 2a of the mixer tube 2 in a radial direction and also functions as a cleaning piston for discharging a liquid agent that remains in the mixing head 1.

The introduction ports 6 and 7 that formed on the upper part of the mixer tube 2 are a first introduction port 6 and a second introduction port 7 described below. The first introduction port 6 is an opening for introducing the liquid agent into the mixer tube 2. The second introduction port 7 is an opening for introducing a substance (a solvent, a cleaning material, air, and the like) for removing the liquid agent into the mixer tube 2. The second introduction port 7 is arranged on a further downstream side (the mix acceleration part 10 side) than the first introduction port 6. The first introduction port 6 and the second introduction port 7 stroke in the axis direction of the mixer tube 2 while the piston 20 is in sliding contact with an inner circumferential surface 2b of the circumferential wall 2a of the mixer tube 2, thereby, one of the first introduction port 6 and the second introduction port 7 is opened, and the other of the first introduction port 6 and the second introduction port 7 is closed.

A first introduction tube 6a that continues to the first introduction port 6 is provided to protrude on an outer circumferential side of the mixer tube 2. A second introduction tube 7a that continues to the second introduction port 7 is provided to protrude on an outer circumferential side of the mixer tube 2. A material supply device (not shown) is connected to the first introduction tube 6a. A cleaning device (not shown) is connected to the second introduction tube 7a.

The material supply device introduces, for example, two types of urethane mix materials into the mixer tube 2 in a mixed state. In an embodiment, a cleaning material can be supplied only to the mixer tube 2 as a place through which the liquid agent after mixing that is supplied from the material supply device passes (that is, a place through which the liquid agent that has an increased viscosity and is easily solidified passes), and it is possible to decrease the amount of a cleaning material, shorten the time required for cleaning, and manufacture a urethane product with a lower cost than the conventional product.

The cleaning device supplies the solvent or air at a high pressure and removes the liquid agent that remains in the mixer tube 2; however, the cleaning device is not limited thereto. The cleaning device may be, for example, a device that supplies a powder cleaning material, may be a device that supplies a cleaning liquid other than a solvent, may be a device that supplies a cleaning material at atmospheric pressure, or may be a device that supplies high-temperature steam. That is, the cleaning material that is introduced into the mixing head 1 may be in any of a liquid phase, a gas phase, and a solid phase. A check valve 7b (a backflow stop valve) is provided on the second introduction tube 7a and prevents backflow of a cleaning material from the inside of the mixer tube 2 to the cleaning device.

The mix acceleration part 10 is constituted of a plurality of two types of elements 11 and 15 on which a plurality of opening portions are formed and which are aligned in the axis direction in the mixer tube 2.

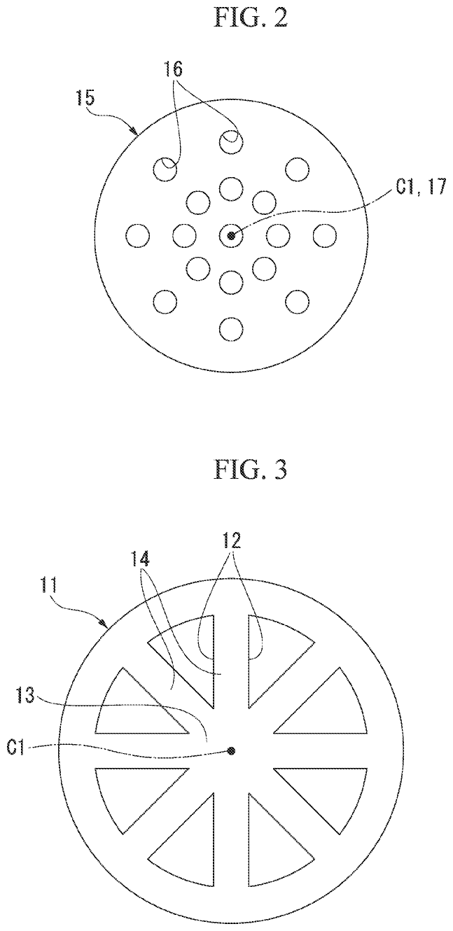

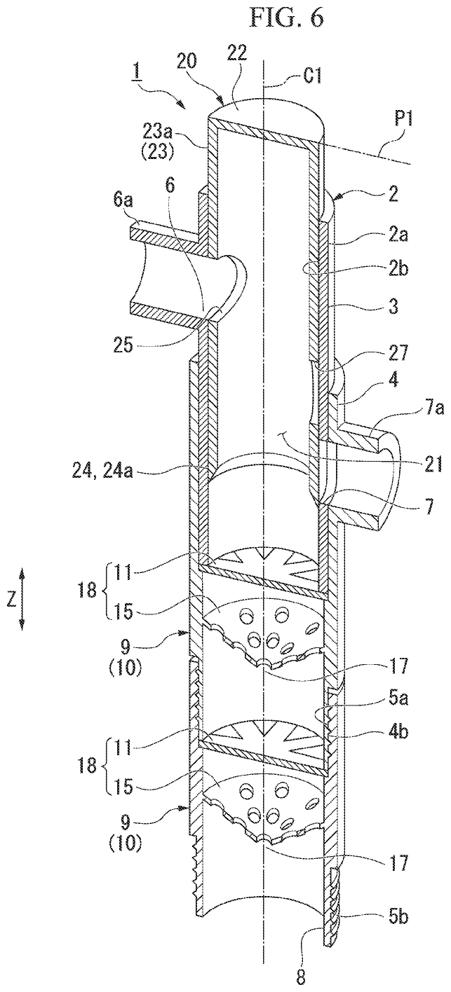

With reference also to FIG. 2, FIG. 3, and FIG. 6, the two types of elements 11 and 15 form a circular shape that is matched with an inner circumference of the mixer tube 2 when seen from the axis direction. The two types of elements 11 and 15 are a first element 11 and a second element 15 described below.

The first element 11 forms a flat plate shape perpendicular to the axis direction. A plurality of first opening parts 12 are formed on the first element 11. Each of the plurality of first opening parts 12 forms a fan shape that extends to an outer circumferential side of the first element 11 in an axis direction view. The plurality of first opening parts 12 are formed on a further outer circumferential side than a central region 13 of the first element 11 to be aligned in the circumferential direction when seen from the axis direction. In the example of FIG. 3, eight first opening parts 12 are provided to be aligned in the circumferential direction. That is, the liquid agent in the mixer tube 2 is divided into eight parts when passing through the first element 11.

By forming a plurality of first opening parts 12 having a fan shape, a plurality of installation pieces 14 that extend to the outer circumferential side from the central region 13 remain in the first element 11. The plurality of installation pieces 14 extend from the central region 13 toward eight directions (four directions which are upward, downward, rightward, and leftward directions and four corners between two of these directions).

The second element 15 defines a form in which a plate member is formed in a substantially conical shape protruding to the downstream side in the axis direction or a substantially hemispherical shape. A plurality of second opening parts 16 are formed on the second element 15. Each of the plurality of second opening parts 16 forms a circular shape having a small diameter in the axis direction view. The plurality of second opening parts 16 include one second opening part 16 that is formed at a central position of the second element 15 and a plurality of second opening parts 16 that are formed and aligned so as to radially extend from the central position when seen from the axis direction. In the example of FIG. 2, two of the plurality of second opening parts 16 that are aligned on the outer side of the central position are aligned from the central position toward eight directions (four directions which are upward, downward, rightward, and leftward directions and four corners between two of these directions). Seventeen second opening parts 16 including the second opening part 16 at the central position are formed on the second element 15. That is, the liquid agent in the mixer tube 2 is divided into seventeen parts when passing through the second element 15.

With reference to FIG. 1 and FIG. 4 to FIG. 6, the mixer tube 2 is divided into a plurality of unit tubes 3, 4, and 5 in the axis direction. In the example of each figure, the mixer tube 2 is divided into a first unit tube 3, a second unit tube 4, and a third unit tube 5 in order from the upstream side, and the mixer tube 2 is constituted by connecting the unit tubes coaxially to one another.

The first unit tube 3 on the most upstream side includes the first introduction port 6 and the first introduction tube 6a for introducing the liquid agent into the mixer tube 2. The piston 20 is fitted in the first unit tube 3 to be capable of stroking.

The second unit tube 4 that continues directly below the first unit tube 3 includes the second introduction port 7 and the second introduction tube 7a for introducing a substance for removing the liquid agent into the mixer tube 2. For example, a lower part of the first unit tube 3 is inserted and fixed to an upper part of the second unit tube 4. A pair of the first element 11 and the second element 15 are held in a lower part of the second unit tube 4. A unit mixer 9 that forms part of the mix acceleration part 10 is constituted of the lower part of the second unit tube 4, the first element 11, and the second element 15. A nozzle in which an opening that is narrower than an inner diameter of the second opening part 16 which is provided on the second element 15 is provided at a front end may be used at the lowermost end of the mix acceleration part 10. Thereby, it is possible to obtain an effect of converging a stream that is spread at the downstream of the element in a mixing apparatus that uses a plurality of elements.

For example, a screw thread 4b formed on an outer circumference of a lower end part of the second unit tube 4 is screwed to a screw thread 5a formed on an inner circumference of an upper end part, and thereby, the third unit tube 5 that continues directly below the second unit tube 4 is coaxially connected to the second unit tube 4. A pair of the first element 11 and the second element 15 is held in the third introduction tube. Similarly to the first unit tube 3, a unit mixer 9 is constituted of the third unit tube 5 and the pair of the first element 11 and the second element 15. A screw thread 5b similar to the screw thread 4b on the outer circumference of the lower end part of the second unit tube 4 is formed on an outer circumference of a lower end part of the third unit tube 5. Thereby, a plurality of unit mixers 9 including the third unit tube 5 can be coaxially connected to each other.

The mixing head 1 of the embodiment is constituted of a plurality of connected unit mixers 9 having a short tube length and can therefore be easily disassembled and cleaned. On the other hand, since the mixing head 1 of the embodiment has a structure that can perform cleaning in which flushing air or a solvent is introduced from the upstream side of the mixer tube 2, and a residual liquid is eliminated in the tube, the frequency of the disassembly and cleaning is reduced. The mix acceleration part 10 of the embodiment is constituted of two unit mixers 9 that are aligned in the axis direction but is not limited to this configuration. The mix acceleration part 10 may be constituted of one unit mixer 9 or three or more unit mixers 9.

The pair of the first element 11 and the second element 15 in the unit mixer 9 constitute an element pair 18. In the element pair 18, a second element 15 having a conical shape is arranged on a further downstream side than a first element 11 having a flat plate shape. The mixing head 1 can be arranged such that the axis direction of the mixer tube 2 is directed in the vertical direction at the time of use and at the time of cleaning. At this time, the second element 15 having a conical shape is arranged at a lower position than the first element 11 having a flat plate shape, and a front end part (a top part 17) of the second element 15 is arranged to face downward (to a gravitational direction). Thereby, a fluid that has passed through the mix acceleration part 10 easily drops or is scattered from the front end of the second element 15 and does not easily remain in the mix acceleration part 10.

In the element pair 18, when seen from the axis direction, the plurality of installation pieces 14 of the first element 11 are arranged so as to overlap the plurality of second opening parts 16 that are aligned on the outside of the central position in the second element 15. The liquid agent that has passed through the first element 11 and has been divided into a plurality of parts is further divided into a plurality of portions when passing through the second element 15. That is, the liquid agent that has passed through one element pair 18 is divided into 17×8=136 portions according to calculation. When the liquid agent has passed through the two element pairs 18 as shown in the figure, the liquid agent is divided into 136×136=18496 portions according to calculation. In this way, the liquid can be favorably stirred and mixed by a step-by-step dividing action.

With reference to FIG. 4 and FIG. 5, the piston 20 closes an upstream-side end part opposite to a downstream-side end part in the mixer tube 2. The piston 20 is formed in a hollow shape having a bottom which opens to the downstream side in the axis direction. A hollow part 21 (internal space) that opens to the downstream side is formed in the piston 20. An upstream-side end portion of the hollow part 21 is positioned at a middle part in the axis direction of the piston 20. A piston bottom wall 22 closes the upstream side of the hollow part 21. A piston outer circumferential wall 23 forms an outer circumferential side of the piston 20.

At least an outer circumferential side of a downstream-side end part 24 in the piston 20 is a liquid agent removal part 24a that removes the liquid agent which adheres to the inner circumferential surface 2b so as to wipe off the liquid agent by causing an outer circumferential surface 23a of the piston outer circumferential wall 23 to come into sliding contact with the inner circumferential surface 2b of the mixer tube 2. In the piston 20 according to the embodiment, the outer circumferential surface 23a of the piston outer circumferential wall 23 as a whole comes into sliding contact with the inner circumferential surface 2b of the mixer tube 2; however, the embodiment is not limited to this configuration. A gap may be provided between the piston 20 and the inner circumferential surface 2b of the mixer tube 2 except for the downstream-side end part 24 and an open/closed part of each introduction port.

The piston 20 can stroke in the axis direction between a first stroke position P1 (refer to FIG. 4) at which the first introduction port 6 is opened and the second introduction port 7 is closed, and a second stroke position P2 (refer to FIG. 5) at which the first introduction port 6 is closed and the second introduction port 7 is opened.

A piston-side first introduction port 25 that penetrates through the piston outer circumferential wall 23 in a radial direction is formed on the downstream side of the piston 20. With reference to FIG. 4, the piston-side first introduction port 25 is arranged so as to overlap the first introduction port 6 when seen from the radial direction when the piston 20 is at the first stroke position P1. The first introduction port 6 and the piston-side first introduction port 25 overlap each other, and thereby, the first introduction port 6 opens to the inside of the mixer tube 2 through the internal space of the piston 20. At this time, the second introduction port 7 is closed by a downstream side of the piston outer circumferential wall 23.

In this state, by introducing the liquid agent into the mixer tube 2 from the first introduction port 6 and causing the liquid agent to flow to the mix acceleration part 10 on a further downstream side than the piston 20, the liquid agent is stirred and mixed by the mix acceleration part 10 (liquid agent mix process).

A radial direction flow path 26 that extends in the radial direction of the mixer tube 2 from an end portion on the upstream side of the hollow part 21 is formed on a middle part in the axis direction of the piston 20. The radial direction flow path 26 penetrates through the piston outer circumferential wall 23 and opens to the outer circumferential surface 23a of the piston outer circumferential wall 23. With reference to FIG. 5, an opening on the outer circumferential side of the radial direction flow path 26 is a piston-side second introduction port 27 that is arranged so as to overlap the second introduction port 7 when seen from the radial direction when the piston 20 is at the second stroke position P2. The second introduction port 7 and the piston-side second introduction port 27 overlap each other, and thereby, the second introduction port 7 opens to the inside of the mixer tube 2 through the internal space of the piston 20. At this time, the first introduction port 6 is closed by the upstream side of the piston outer circumferential wall 23.

In this state, a substance for removing the liquid agent is introduced into the mixer tube 2 from the second introduction port 7, and the liquid agent or the like that remains in the mix acceleration part 10 is washed away or blown away by the substance and is removed (liquid agent removal process).

In this way, by arranging the second introduction port 7 that introduces a substance for removing the liquid agent between the piston 20 for removing the liquid agent and the mix acceleration part 10 (on the further upstream side than the mix acceleration part 10), introducing a substance for removing the liquid agent from the second introduction port 7, and cleaning the mix acceleration part 10, it is possible to efficiently remove a residual liquid and improve the cleaning performance in the mixing head 1.

The piston 20 of FIG. 6 defines a cylindrical shape having a bottom and is formed such that the hollow part 21 (internal space) that opens to the downstream side is provided over the entire axis direction. In the piston 20 of FIG. 4 and FIG. 5, the piston-side second introduction port 27 is arranged on a further upstream side than the piston-side first introduction port 25.

On the other hand, in the piston 20 of FIG. 6, the piston-side second introduction port 27 is arranged on a further downstream side than the piston-side first introduction port 25. Since the second introduction port 7 of the mixer tube 2 is arranged on a further downstream side than the first introduction port 6, in the arrangement of introduction ports 25 and 27 of the piston 20 in FIG. 6, the stroke of the piston 20 at the time of switching between the liquid agent mix process and the liquid agent removal process is small compared to the arrangement of FIG. 4 and FIG. 5.

As described above, the mixing head 1 in the embodiment described above is a mixing apparatus in which through the mixer tube 2 having the mix acceleration part 10 a plurality of liquid agents are flowed in the axis direction of the mixer tube 2 and are mixed, the apparatus including: the first introduction port 6 that is provided on a further upstream side in a flow direction of the liquid agent than the mix acceleration part 10 in the inner circumferential surface 2b of the mixer tube 2 and allowing introduction of the liquid agent; the second introduction port 7 that is provided on the further upstream side in the flow direction of the liquid agent than the mix acceleration part 10 in the inner circumferential surface 2b of the mixer tube 2 and allowing introduction of a substance for removing the liquid agent; and the piston 20 that is provided on the upstream side of the mixer tube 2 and that opens one of the first introduction port 6 and the second introduction port 7 and closes another of the first introduction port 6 and the second introduction port 7 by stroking in the axis direction of the mixer tube 2 while being in sliding contact with the inner circumferential surface 2b.

According to this configuration, since the first introduction port 6 and the second introduction port 7 are selectively opened and closed using the piston 20 in the mixer tube 2 as a valve, it is possible to easily switch between a liquid agent mix process and a liquid agent removal process. That is, the piston 20 strokes to a position where the first introduction port 6 is opened and the second introduction port 7 is closed, and thereby, it is possible to perform the liquid agent mix process in which the liquid agents are mixed. Further, the piston 20 strokes to a position where the first introduction port 6 is closed and the second introduction port 7 is opened, and thereby, it is possible to perform the liquid agent removal process in which the liquid agents that remain in the mixer tube 2 are removed. In the liquid agent removal process, since the material for cleaning is introduced from the further upstream side than the mix acceleration part 10, it is possible to facilitate removal of the liquid agent that remains in the mix acceleration part 10 and improve the cleaning performance of the mixing apparatus.

In the mixing head 1 described above, the mix acceleration part 10 is constituted of a plurality of elements 11 and 15 on which a plurality of opening portions 12 and 16 are formed and which facilitate mixing of the liquid agents that are aligned in the axis direction, the elements 11 and 15 include: a first element 11 which forms a flat plate shape that crosses the axis direction and on which a plurality of first opening portions 12 are formed; and a second element 15 which forms a conical shape protruding to a downstream side opposite to the upstream side in the axis direction and on which a plurality of second opening portions 16 are formed, the first element 11 and the second element 15 form a pair with each other and constitute an element pair 18, and the second element 15 having a conical shape is arranged on the further downstream side than the first element 11 having a flat plate shape in the element pair 18.

According to this configuration, in the element pair 18 constituted of the first element 11 having a flat plate shape and the second element 15 having a conical shape, since the second element 15 having a conical shape is arranged on the downstream side, when a material for cleaning is introduced from the upstream side in the liquid agent removal process, the liquid agent is easily discharged to the downstream side from the front end (the top part 17) protruding to the downstream side in the second element 15. Therefore, it is further difficult for the liquid agent to remain in the mixer tube 2, and it is possible to improve the cleaning performance of the mixing apparatus.

In the mixing head 1 described above, the piston 20 includes a liquid agent removal part 24a that is formed on the outer circumferential side of the downstream-side end part 24, is in sliding contact with the inner circumferential surface 2b of the mixer tube 2, and removes a liquid agent which adheres to the inner circumferential surface 2b.

According to this configuration, since the liquid agent removal part 24a removes the liquid agent that adheres to the inner circumferential surface 2b of the mixer tube 2 in accordance with the stroke of the piston 20, it is further difficult for the liquid agent to remain in the liquid agent removal process, and it is possible to improve the cleaning performance of the mixing apparatus. Further, it is possible to prevent the liquid agent from flowing to the further upstream side than the liquid agent removal part 24a and prevent the liquid agent from flowing into the first introduction port 6 or the second introduction port 7 that is closed by the piston 20.

In the mixing head 1 described above, the piston 20 is formed in a hollow shape having a bottom that opens to a downstream side opposite to the upstream side in the axis direction, and a piston outer circumferential surface 23 on a further upstream side than the liquid agent removal part 24a in the piston 20 includes: a piston-side first introduction port 25 that overlaps the first introduction port 6 in a view from a radial direction of the mixer tube 2 and opens the first introduction port 6 through an internal space (the hollow part 21) of the piston 20 when the piston 20 is at a first stroke position P1 that closes the second introduction port 7; and a piston-side second introduction port 27 that overlaps the second introduction port 7 in the view from the radial direction of the mixer tube 2 and opens the second introduction port 7 through the internal space of the piston 20 when the piston 20 is at a second stroke position P2 that closes the first introduction port 6.

According to this configuration, since the first introduction port 6 and the second introduction port 7 are opened through the internal space of the hollow piston 20, it is possible to easily realize switching between opening and closing of the first introduction port 6 and the second introduction port 7 using the piston 20 as a valve.

Further, since the substance for removing the liquid agent is introduced from the further upstream side than the liquid agent removal part 24a of the piston 20, it is possible to remove the liquid agent efficiently and in a wide range including the vicinity of the liquid agent removal part 24a.

In the mixing head 1 described above, the second introduction port 7 that allows introduction of the substance for removing the liquid agent is arranged on a further downstream side opposite to the upstream side than the first introduction port 6 that allows introduction of the liquid agent.

According to this configuration, since the second introduction port 7 that introduces the substance for removing the liquid agent is arranged close to the mix acceleration part 10, it is possible to further easily remove the liquid agent in the liquid agent removal process and improve the cleaning performance of the mixing apparatus.

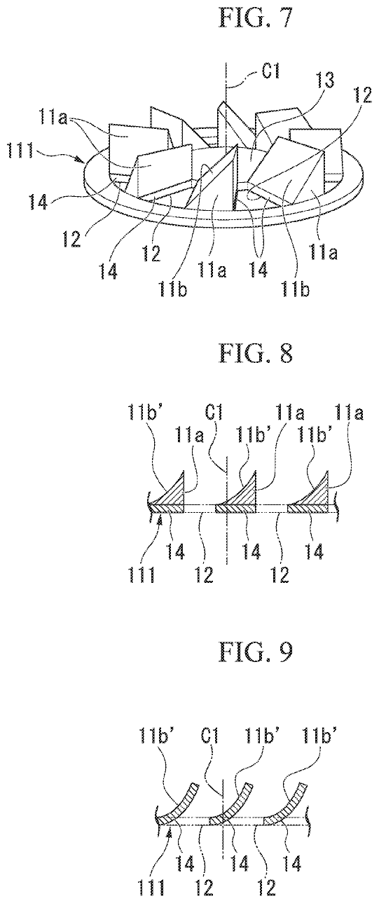

FIG. 7 shows a modified example of the first element 11 of the embodiment. A first element 111 of the modified example includes a protrusion 11a that is provided on the upstream side of a plurality of remaining parts (installation pieces 14) and defines a substantially triangular shape in a radial direction view. Each projection 11a forms an inclination surface 11b (a guide surface) that is inclined to be positioned on one side in the circumferential direction toward a downstream side from the front end on the upstream side. According to this configuration, when the liquid agent that flows to the downstream side in the mixer tube 2 passes through the first element 111, the liquid agent is guided to the one side in the circumferential direction by a plurality of inclination surfaces 11b, and accordingly, the liquid agent is caused to generate a swirl flow to the one side in the circumferential direction. Thereby, the liquid agent is further favorably stirred and mixed.

In FIG. 7, the inclination surface 11b having a flat shape is formed on the upstream side of the first element 11; however, the embodiment is not limited to this configuration. For example, as shown in FIG. 8, a configuration may be used in which a curved surface 11b′ is formed that is inclined to be positioned on one side in the circumferential direction toward the downstream side and that is concavely curved when seen from the radial direction.

Further, in FIG. 7 and FIG. 8, a solid projection 11a is formed on the installation piece 14; however, the embodiment is not limited to this configuration. For example, as shown in FIG. 9, an installation piece 14 having a plate shape may be curved (or inclined), and the curved surface 11b′ (or an inclination surface 11b) may be formed.

As described above, in the mixing head 1 in the modified example described above, the mix acceleration part 10 includes a first element 111, the first element 111 includes a plurality of installation pieces 14 that avoid the first opening portions 12 and are aligned in a circumferential direction of the mixer tube 2, and a guide surface (the inclination surface 11b or the curved surface 11b′) that is inclined to be positioned on one side of the circumferential direction toward a downstream side from the upstream side is formed on the upstream side of the installation piece 14.

According to this configuration, since the guide surface that is inclined toward the one side in the circumferential direction is formed on the plurality of installation pieces 14 that are aligned in the circumferential direction in the first element 11, the liquid agent is guided to be swirled in the circumferential direction by a plurality of guide surfaces when the liquid agent passes through the mix acceleration part 10. Thereby, it is possible to further efficiently perform mixing of the liquid agent.

### Second Embodiment

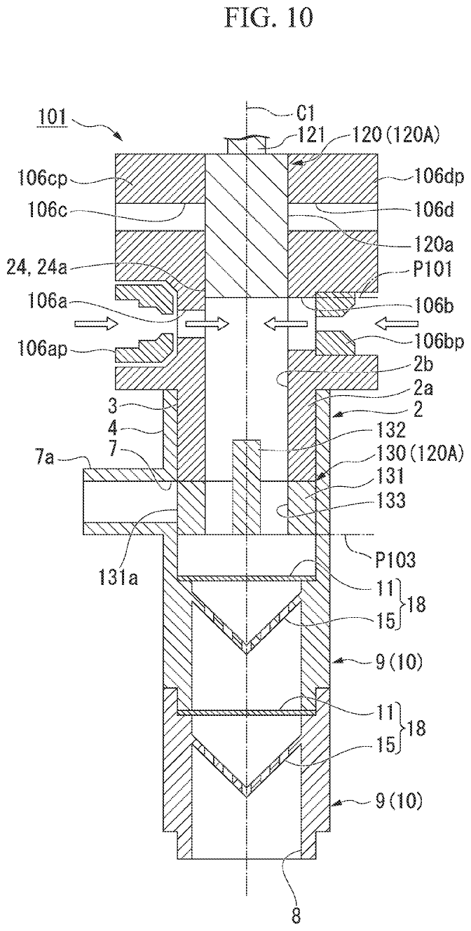

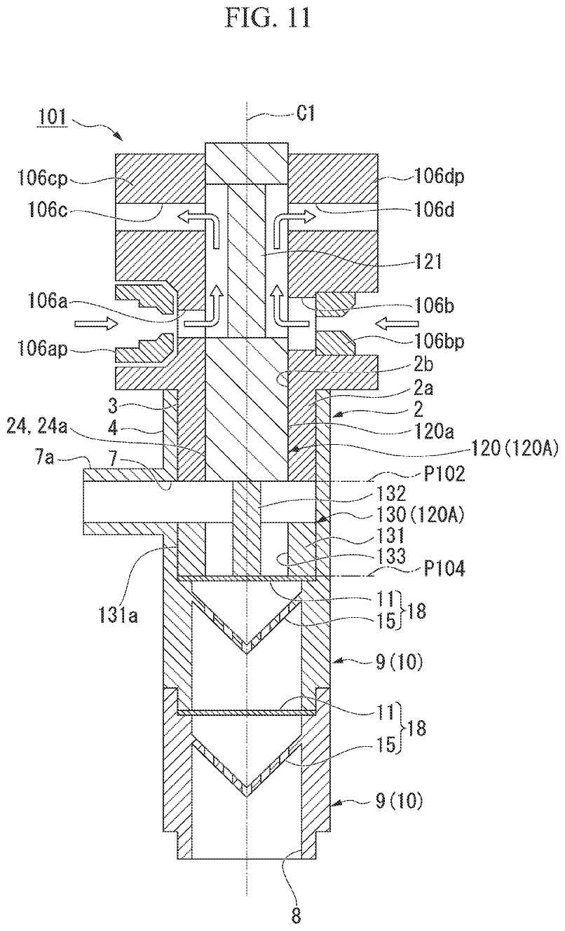

Next, a second embodiment of the present invention will be described with reference to FIG. 10 and FIG. 11 also referring to FIG. 1 to FIG. 9.

The second embodiment is particularly different from the embodiment described above (the first embodiment) in that the piston described above (a piston 120A) is divided into a first piston (a piston main body 120) and a second piston (a valve 130) in an axis direction, and separate introduction ports 106a and 106b are provided for each liquid agent to be mixed. The same reference numerals are given to the same configurations as those of the first embodiment, and detailed description thereof is omitted.

A mixing head 101 shown in in FIG. 10 and FIG. 11 is a mixer for mixing a two-liquid curable resin, for example, when forming a urethane pad similarly to the first embodiment. In the mixing head 101, through a mixer tube 2 having a cylindrical shape and extending straight, a plurality of liquid agents (molding materials) supplied by a material supply device (not shown) are caused to flow in an axis direction of the mixer tube 2, are caused to pass through a mix acceleration part 10 of the mixer tube 2, are stirred and mixed, and are then derived from an end opening (a derivation port 8) of the mixer tube 2. The mixing head 101 is constituted as a stationary mixing apparatus without a drive part.

Similarly to the first embodiment, the mixing head 101 of the second embodiment is also arranged in a posture in which the axis direction of the mixer tube 2 is directed in a vertical direction, and a lower end opening of the mixer tube 2 is the derivation port 8; however, the embodiment is not limited to the use in this arrangement. A line C1 in the drawing represents a center axis line of the mixer tube 2.

The mixer tube 2 includes a mix acceleration part 10 at a lower part on the derivation port 8 side (downstream side). A piston 120A is inserted in an upper part on the upstream side of the mixer tube 2 and is held.

The piston 120A is divided into a piston main body 120 and a valve 130 in the axis direction. Similarly to the piston 20 of the first embodiment, the piston main body 120 is connected to a drive source (not shown) and is driven by a drive force of the drive source. The valve 130 is capable of being held at a predetermined axis direction position to be separated from the piston 120 by a bias force different from the drive force.

The piston main body 120 functions as a valve that strokes between a first stroke position P101 at which a plurality (a pair) of introduction ports 106a and 106b that penetrate through an upper part of a circumferential wall 2a of the mixer tube 2 in a radial direction communicate with a side of the mix acceleration part 10 and a second stroke position P102 at which the plurality of introduction ports 106a and 106b communicate with a side of a plurality of circulation ports 106c and 106d, and also functions as a cleaning piston for discharging a liquid agent that remains in the mixing head 101. The pair of introduction ports 106a and 106b face each other in the radial direction in the mixer tube 2.

The plurality of introduction ports 106a and 106b are openings for separately introducing two liquid agents before mixing into the mixer tube 2.

When the piston main body 120 is at the first stroke position P101, the plurality of introduction ports 106a and 106b communicate with the mix acceleration part 10 through a space around a shaft part 121 and allow the liquid agent to be capable of being supplied to the mix acceleration part 10 side. At this time, the plurality of circulation ports 106c and 106d are closed by an outer circumferential surface 120a of the piston main body 120a.

When the piston main body 120 is at the second stroke position P102, the plurality of introduction ports 106a and 106b communicate with the circulation ports 106c and 106d side through the space around the shaft part 121 and allow the liquid agent to be capable of circulating to the plurality of circulation ports 106c and 106d. At this time, the mix acceleration part 10 side is closed by a lower part of the piston main body 120.

The valve 130 opens and closes a second introduction port 7 for introducing a substance (a solvent, a cleaning material, air, and the like) for removing the liquid agent into the mixer tube 2. The valve 130 includes a valve main body 131 that has a circular plate shape and is fitted into the mixer tube 2 and a protrusion part 132 that protrudes upward from a middle part of the valve main body 131. The second introduction port 7 is arranged on a further downstream side (the mix acceleration part 10 side) than the introduction ports 106a and 106b. The second introduction port 7 is opened and closed by stroking in the axis direction of the mixer tube 2 while the valve main body 131 is in sliding contact with the inner circumferential surface 2b of the circumferential wall 2a of the mixer tube 2.

The valve 130 is separated from the piston main body 120 in the axis direction and strokes upward by a bias force such as a magnetic force when the piston main body 120 is moved upward and is at the first stroke position P101. Specifically, the valve 130 is held at a predetermined axis direction position, for example, by using an attraction force between a steel material of the mixer tube 2 and a magnet embedded in the valve 130 and a repulsion force between the magnet embedded in the valve 130 and a magnet embedded in the inside of the mixer tube 2. The valve 130 is fixed in a closing state where the second introduction port 7 is closed when the valve 130 is not pushed downward by the piston main body 120. At this time, the valve 130 is arranged at a first valve stroke position P103 at which the second introduction port 7 is closed by an outer circumferential surface 131a of the valve main body 131.

By the piston main body 120 being moved downward and coming into contact with the protrusion part 132, the valve 130 is pushed downward and becomes an open state in which the second introduction port 7 is opened. The valve 130 strokes downward against the bias force by the protrusion part 132 being pushed downward in the axis direction by the piston main body 120 when the piston main body 120 is moved downward and is at the second stroke position P102. At this time, the valve 130 is arranged at a second valve stroke position P104 at which the valve main body 131 causes the second introduction port 7 to open to the upside (the introduction ports 106a and 106b side).

A flow path 133 that allows the liquid agent and the cleaning material to be capable of flowing in the axis direction is formed on an inner circumferential side of the valve main body 131.

When the valve 130 is moved upward and is at the first valve stroke position P103, the second introduction port 7 is closed by the outer circumferential surface 131a of the valve 130, and high-pressure liquid agents that are introduced into the mixer tube 2 through orifices of the introduction ports 106a and 106b collide and are mixed with each other directly below the piston main body 120, flow out downward, pass through the flow path 133 of the valve 130, and arrive at the mix acceleration part 10 side.

When the valve 130 is moved downward and is at the second valve stroke position P104, the second introduction port 7 is opened to an upper side of the valve 130, and a liquid agent that is introduced from the second introduction port 7 to the upper side of the valve 130 passes through the flow path 133 of the valve 130 and arrives at the mix acceleration part 10 side.

Introduction ports 106ap and 106bp that continue to the introduction ports 106a and 106b open at an outer circumferential side of the mixer tube 2. Circulation ports 106cp and 106dp that continue to the circulation ports 106c and 106d open at an outer circumferential side of the mixer tube 2. A second introduction tube 7a that continues to the second introduction port 7 is provided to protrude on an outer circumferential side of the mixer tube 2. A material supply device (not shown) is connected to the introduction ports 106ap and 106bp and the circulation ports 106cp and 106dp. A cleaning device (not shown) is connected to the second introduction tube 7a. The cleaning device supplies the solvent or air at a high pressure and removes the liquid agent that remains in the mixer tube 2; however, the cleaning device is not limited thereto. The cleaning device may be, for example, a device that supplies a powder cleaning material, may be a device that supplies a cleaning liquid other than a solvent, may be a device that supplies a cleaning material at atmospheric pressure, or may be a device that supplies high-temperature steam. That is, the cleaning material that is introduced into the mixing head 101 may be in any of a liquid phase, a gas phase, and a solid phase. A check valve (a backflow stop valve) may be provided on the second introduction tube 7a and may prevent backflow of a cleaning material from the inside of the mixer tube 2 to the cleaning device.

The mix acceleration part 10 is constituted of a plurality of two types of elements 11 and 15 on which a plurality of opening portions are formed and which are aligned in the axis direction in the mixer tube 2. The configuration and the action of each element 11, 15 is the same as those of the first embodiment. The point that the mixer tube 2 is divided into a plurality of unit tubes 3, 4, and 5 in the axis direction is also the same as that of the first embodiment.

At least an outer circumferential side of a downstream-side end part 24 in the piston main body 120 is a liquid agent removal part 24a that removes the liquid agent which adheres to the inner circumferential surface 2b so as to wipe off the liquid agent by causing the outer circumferential surface 120a of the piston main body 120 to come into sliding contact with the inner circumferential surface 2b of the mixer tube 2.

When the piston main body 120 is at the first stroke position P101 (refer to FIG. 10), the liquid agent is introduced into the mixer tube 2 from the introduction ports 106a and 106b. By causing the liquid agent to flow to the mix acceleration part 10 on a lower side (downstream side) than the piston main body 120, the liquid agent is stirred and mixed by the mix acceleration part 10 (liquid agent mix process).

When the piston main body 120 is at the second stroke position P102 (refer to FIG. 11), the liquid agent is circulated from the introduction ports 106a and 106b to the circulation ports 106c and 106d, and a material for removing the liquid agent is introduced into the mixer tube 2 from the second introduction port 7. By causing the substance to flow to the mix acceleration part 10, the liquid agent or the like that remains in the mix acceleration part 10 is washed away or blown away and is removed (liquid agent removal process).

In this way, by arranging the second introduction port 7 that introduces a substance for removing the liquid agent between the piston main body 120 for removing the liquid agent and the mix acceleration part 10 (on the further upstream side than the mix acceleration part 10), introducing a substance for removing the liquid agent from the second introduction port 7, and cleaning the mix acceleration part 10, it is possible to efficiently remove a residual liquid and improve the cleaning performance in the mixing head 101.

As described above, even in the mixing head 101 of the second embodiment, since the pair of introduction ports 106a and 106b, and the second introduction port 7 are selectively opened and closed using the piston 120A in the mixer tube 2 as a valve, it is possible to easily switch between a liquid agent mix process and a liquid agent removal process. That is, the piston 120A strokes to a position where the pair of introduction ports 106a and 106b are opened and the second introduction port 7 is closed, and thereby, it is possible to perform the liquid agent mix process in which the liquid agents are mixed. Further, the piston 120A strokes to a position where the pair of introduction ports 106a and 106b are closed and the second introduction port 7 is opened, and thereby, it is possible to perform the liquid agent removal process in which the liquid agents that remain in the mixer tube 2 are removed. In the liquid agent removal process, since the material for cleaning is introduced from the further upstream side than the mix acceleration part 10, it is possible to facilitate removal of the liquid agent that remains in the mix acceleration part 10 and improve the cleaning performance of the mixing apparatus.

In the mixing head 101 described above, the piston 120A is divided into a first piston (the piston main body 120) and a second piston (the valve 130) in the axis direction, one (the piston main body 120) of the first piston and the second piston is connected to a drive source and is driven by a drive force of the drive source, the other (the valve 130) of the first piston and the second piston is capable of being held at a predetermined axis direction position to be separated from the one by a bias force different from the drive force, and the other of the first piston and the second piston is capable of stroking from the axis direction position against the bias force by the one stroking and being engaged with the other.

According to this configuration, since the piston that opens and closes the first introduction port and the second introduction port is divided and can stroke separately, it is possible to realize an irregular operation at the time of switching of the process such as an operation in which a separation piston is held at the predetermined axis direction position and maintains a prescribed flow path open/closed state while increasing the stroke of a drive piston and enhancing the degree of freedom of the flow path switching.

The configurations in the embodiments described above are merely examples of the present invention. For example, the combination of elements of the mix acceleration part is not limited to the combination of the flat plate shape and the conical shape, and various combinations are conceivable. For example, it is not necessary to use both the first and second elements. Only a single type of element may be used, or a specification in which the number of elements is only one may be used. Various modifications such as a modification in which a component of each embodiment is replaced by a well-known component can be made without departing from the scope of the present invention.

What is claimed is:

1. A mixing apparatus in which through a mixer tube having a mix acceleration part a plurality of liquid agents are flowed in an axis direction of the mixer tube and are mixed, the apparatus comprising:
a first introduction port that is provided on a further upstream side in a flow direction of a liquid agent than the mix acceleration part in the mixer tube and allows introduction of the liquid agent;
a second introduction port that is provided on the further upstream side in the flow direction of the liquid agent than the mix acceleration part in the mixer tube and allows introduction of a substance for removing the liquid agent; and
a piston that is provided on the upstream side of the mixer tube and that opens one of the first introduction port and the second introduction port and closes another of the first introduction port and the second introduction port by stroking in the axis direction of the mixer tube.

2. The mixing apparatus according to claim 1,
wherein the piston comprises a liquid agent removal part that is formed on an outer circumferential side on an end part on a downstream side opposite to the upstream side in the axis direction, is in sliding contact with an inner circumferential surface of the mixer tube, and removes a liquid agent which adheres to the inner circumferential surface.

3. The mixing apparatus according to claim 2,
wherein the piston is formed in a hollow shape having a bottom that opens to a downstream side opposite to the upstream side in the axis direction, and
a piston outer circumferential surface on a further upstream side than the liquid agent removal part in the piston comprises:
a piston-side first introduction port that overlaps the first introduction port in a view from a radial direction of the mixer tube and opens the first introduction port through an internal space of the piston when the piston is at a first stroke position that closes the second introduction port; and
a piston-side second introduction port that overlaps the second introduction port in the view from the radial direction of the mixer tube and opens the second introduction port through the internal space of the piston when the piston is at a second stroke position that closes the first introduction port.

4. The mixing apparatus according to claim 1,
wherein the piston is divided into a first piston and a second piston in the axis direction,
one of the first piston and the second piston is connected to a drive source and is driven by a drive force of the drive source,
the other of the first piston and the second piston is capable of being held at a predetermined axis direction position to be separated from the one by a bias force different from the drive force, and
the other of the first piston and the second piston is capable of stroking from the axis direction position against the bias force by the one stroking and being engaged with the other.

5. The mixing apparatus according to claim 1,
wherein the second introduction port that allows introduction of the substance for removing the liquid agent is arranged on a further downstream side opposite to the upstream side than the first introduction port that allows introduction of the liquid agent.

6. The mixing apparatus according to claim 1,
wherein the mix acceleration part comprises an element on which a plurality of opening portions are formed and which facilitates mixing of the liquid agent,
the element comprises a plurality of remaining parts that avoid the opening portions and are aligned in a circumferential direction of the mixer tube, and
a guide surface that is inclined to be positioned on one side of the circumferential direction toward a downstream side from the upstream side is formed on the upstream side of the remaining parts.

7. The mixing apparatus according to claim 1,
wherein the mix acceleration part is constituted of a plurality of elements on which a plurality of opening portions are formed, which facilitate mixing of the liquid agent, and which are aligned in the axis direction,
each of the elements includes: a first element which forms a flat plate shape that crosses the axis direction and on which a plurality of first opening portions are formed; and a second element which forms a conical shape protruding to a downstream side opposite to the upstream side in the axis direction and on which a plurality of second opening portions are formed,
the first element and the second element form a pair with each other and constitute an element pair, and
the second element having a conical shape is arranged on the further downstream side than the first element having a flat plate shape in the element pair.
